(19) United States
(12) Patent Application Publication
(10) Pub. No.: US 2006/0247902 A1
(43) Pub. Date: Nov. 2, 2006

(54) Hybride 3D path router

(76) Inventor: Patrick W. Rourke, Titusville, FL (US)

Correspondence Address: LAW OFFICES OF BRIAN S STEINBERGER, 101 BREVARD AVENUE, COCOA, FL, 32922, US

(21) Appl. No.: 11/414,463

(22) Filed: Apr. 28, 2006

Related U.S. Application Data
(60) Provisional application No. 60/676,042, filed on Apr. 29, 2005.

(51) Int. Cl. G06F 17/50

(52) U.S. Cl. 703/1; 703/9

(57) ABSTRACT

Computer aided design(CAD) methods and systems of routing pipes, ducts and other services, such as utility and HVAC(Heating Ventilation and Cooling) lines in three dimensions(3D) through congested areas in industrial plants, ships, land vehicles, air vehicles, structures, buildings, and the like. The invention combines high speed real-time two dimensional router software and a simple graphical user interface to create an environment in which a designer can rapidly create fully valid 3D(three dimensional) routes for piping, HVAC(Heating, Ventilation and Air Conditioning) ducting, cableways and other swept shapes. The designer can use the invention to generate optimal 3D routes nearly as fast as the designer can move his/her mouse, and the invention can be imbedded within existing 3D(three dimensional) CAD(computer aided design) systems.

This invention claims the benefit of priority to U.S. Provisional Patent Application Ser. No. 60/676,042 filed Apr. 29, 2005.

### FIELD OF INVENTION

This invention relates to computer aided design (CAD) methods and systems for the routing of conduits, namely pipes, ducts and other services, in three dimensions(3D) through congested areas in industrial plants, ships, land vehicles, aircraft and structures.

### BACKGROUND AND PRIOR ART

The routing of pipes, ducts, and other services in three dimensions (3D) through congested areas, is difficult, even using the best available commercial 3D computer aided design (CAD) systems. Current practice is to manually draft the routes using a 3D CAD system. The CAD systems provide the designer with tools for performing geometrical constructions, such as placing lines and arcs in space, and defining the lines and arcs to be the path for a pipe, duct, or other service. The CAD systems allow the designer to view the geometry from a variety of directions, and may tell the designer after the fact if the route that has been input is invalid because it would cause the pipe or duct or other service to pass through some fixed object, such as a piece of equipment. What CAD systems do not do is provide any guidance to the designer on where to place the route.

This problem of how to automatically route pipe has been widely studied, and a number of automatic software solutions have been proposed over the years. Examples of work in this field include:[1] Glenn E. Wangdahl, Stephen M. Pollock, and John B. Woodward, Minimum-Trajectory Pipe Routing, Journal of Ship Research, Vol. 18, No. 1, March 1974, pp. 46-49; [2] Rourke, Patrick W, Ph.D. Computerized Routing of Piping, Thesis, Dept. of Mechanical Engineering, Lehigh University, 1975; and [3] Zhu, David (Dept of Computer Sci., Stanford Univ., Calif., USA), Latombe, Jean-Claude, Source, Pipe routing=path planning (with many constraints), Proceedings—IEEE International Conference on Robotics and Automation, v 3, 1991, p 1940-1947 Conference: Proceedings of the 1991 IEEE International Conference on Robotics and Automation, Apr 9-11 1991, Sacramento, Calif., USA.

Both references [1] Glenn E. Wangdahl, Stephen M. Pollock, and John B. Woodward, Minimum-Trajectory Pipe Routing, Journal of Ship Research, Vol.18, No. 1, March 1974, pp. 46-49; and [2] Rourke, Patrick W, Ph.D. Computerized Routing of Piping, Thesis, Dept. of Mechanical Engineering, Lehigh University, 1975 generally describe overly simplified geometric models and algorithms which could not scale up to handle real world problems.

Reference [3] Zhu, David (Dept of Computer Sci., Stanford Univ., Calif., USA), Latombe, Jean-Claude, Source, Pipe routing=path planning (with many constraints), Proceedings—IEEE International Conference on Robotics and Automation, v 3, 1991, p 1940-1947 Conference: Proceedings of the 1991 IEEE International Conference on Robotics and Automation, Apr 9-11 1991, Sacramento, Calif., USA, used a simplified geometric technique for pipe routing which only allows for rectilinear paths.

U.S. Pat. No. 5,119,317, to Narikawa et al. describes an automatic routing system based on voxel decomposition of space and Manhatten routing of pipes. In the congested areas found in ships and vehicles, non-rectilinear routes are required, which this technique cannot generate. Computer memory requirements and solution times also increase dramatically as spatial resolution is tightened to handle congested areas.

Commercial pipe router software for early stage plant design has been developed and deployed by ASD (www.asdglobal.com), Alias (www.alias.ltd.uk) and Aveva (www.aveva.com). These routers are all limited to rectilinear paths, and are thus not capable of being used for pipe routing in congested areas such as in ships and vehicles. Further, they do not address the harder problem of routing more complex shapes such as heating, ventilation and air conditioning (HVAC) ducts.

U.S. Patent Application Publication 2003/0101029A1 to Drumheller, describes a “Constraint-Based Method of Designing a Route For a Transport Element”, title. The Drumheller reference gives an approach for detail design of individual pipe routes in which a designer gives a series of geometric inequality constraints, which are then solved by the system to generate a 3D path. That approach requires that the designer already have a rough 3D route, and requires significant labor by the designer to input a set of constraints. By contrast, the approach presented in this published patent application is intended to be used to aid designers in rapidly developing both rough and final 3D routes.

Further, the approach used by Drumheller does not address more complex shapes, such as HVAC ducting and cableways. As with other automatic routing techniques, the computational complexity of the problem being solved by Drumheller is such that solution times are in minutes, which makes it unsuitable for interactive design tool environments where real time feedback is needed.

In general, the prior art solutions suffer from various problems. For example, current solutions generally require extensive up front input by the user to state all of the design rules and constraints, so that the router can generate a valid route. Current solutions generally take minutes or hours to compute path routes, prohibiting them from being imbedded directly in an interactive design tool. Most current solutions are limited to rectilinear paths, and are thus not capable of being used in the congested areas typical of ships and vehicles.

Thus, the need exists for solutions to the above problems with the prior art.

### SUMMARY OF THE INVENTION

A primary objective of the present invention is to provide a computer aided design system and method which combines high speed real-time two dimensional router software and a simple graphical user interface to create an environment in which a designer can rapidly create fully valid 3D(three dimensional) routes for piping, HVAC(Heating, Ventilation and Air Conditioning) ducting , cableways and other swept shapes.

A secondary objective of the present invention is to provide a computer aided design system and method which provides the designer with a tool which can generate optimal 3D routes nearly as fast as the designer can move his/her mouse.

A third objective of the present invention is to provide a computer based method and system that can be imbedded within existing 3D(three dimensional) CAD(computer aided design) systems.

A fourth objective of the present invention is to provide a computer based method and system that can provide optimal 3D routes in congested areas such as those found in ships, aircraft and vehicles, and the like, and are not limited to rectilinear paths.

A fifth objective of the present invention is to provide a computer based method and system that does not require extensive up front input by the user to state all of the design rules and constraints, in order for the router to generate a valid route.

A preferred method of routing conduits such as ducts and pipes through congested areas can include the steps of specifying object dimension size and object shape to be

routed through a space, sketching a 2D(two dimensional) guide path for the object through the space, calculating 2D(two dimensional) slices through a 3D(three dimensional) world for the guide path, determining optimum 2D route through the 2D slices, and converting the optimum 2D route to an optimum 3D route.

The method can further include the steps of displaying the 3D route for review, modifying the 2D path if the 3D route in unacceptable, and repeating step, and finalizing object path route if the displayed 3D route is acceptable.

The space can be a congested space, such as inside of a ship, a land vehicle and an aircraft. The congested space can be inside of an industrial plant, a building and a structure.

The conduit being routed may be the removal and/or installation path for a piece of equipment wherein the router plans how the equipment will be installed and/or removed for service.

The invention can be imbedded in a CAD(computer aided design) system, with the routing taking place in real time, and the invention combines a real-time 2D(two dimensional) router and an intuitive graphical user interface to create an interactive 3D(three dimensional) router.

The step of specifying dimensions and object shape to be routed can further include the steps of specifying manufacturing and installation and operability rules of the object to be routed through the space.

The step of calculating 2D(two dimensional) slices through a 3D(three dimensional) world for the guide path, can further include the steps of determining objects to be avoided in the sketch path, and projecting the objects to be avoided onto the slice planes.

The step of calculating 2D(two dimensional) slices through a 3D(three dimensional) world for the guide path, can further include the steps forming bit path masks by the objects to be avoided and the slices, and comparing the bit path masks to determine the optimum 2D route.

The step of calculating 2D(two dimensional) slices through a 3D(three dimensional) world for the guide path, can further include the steps converting geometry of the objects to be avoided into bit map image masks of the objects to be avoided, and comparing the bit map image masks to determine the optimum 2D route.

The step of calculating 2D(two dimensional) slices through a 3D(three dimensional) world for the guide path, can further include the step of generating a guidance cost function for the router by using a diffusion operator on the bit map image of the objects to be avoided.

The invention can use interface manipulator handles to control and modify a 2D guide path to define a linked set of 3D guide planes.

The step of calculating 2D(two dimensional) slices through a 3D(three dimensional) world for the guide path, can further include the step of constructing bitmap based voxel representations of the objects to be avoided by 3D graphics hardware.

The step of calculating 2D(two dimensional) slices through a 3D(three dimensional) world for the guide path, can further include the step of combining discrete and continuous path routing with an A* algorithm.

A preferred system for routing conduits such as ducts and pipes through congested areas, can comprise software and components that result in the methodology.

Further objects and advantages of this invention will be apparent from the following detailed description of the presently preferred embodiments which are illustrated schematically in the accompanying drawings.

### BRIEF DESCRIPTION OF THE FIGURES

FIG. 1 is a block diagram of the major components of the Hybrid 3D Path Router

FIG. 2 is a flow chart of overall flow and user interaction of the Hybrid 3D Path Router

FIG. 3 shows a possible user interface for entering path parameter data.

FIG. 4 shows a two dimensional(2D) guide path sketched in a 3D view.

FIG. 5 rotates the view to show the three dimensional(3D) slice planes of FIG. 4.

FIG. 6 shows computed slice bitmaps of the three dimensional slice planes of FIG. 5.

FIG. 7 shows an optimum 2D path following the slice bitmaps of FIG. 6.

FIG. 8 shows the 3D path corresponding to FIG. 7.

FIG. 9 shows manipulation handles exposed by the guide path in the 3D view

FIG. 10 shows the result of dragging one of the guide path handles with the computer mouse.

FIG. 11 shows the new optimum 3D path computed corresponding to FIG. 10.

FIG. 12 shows the components of a typical computer system for 3D design.

FIG. 13 shows the image mask for a particular bend.

FIG. 14 shows the bend image mask overlaid on a section of the objects to avoid bitmap.

FIG. 15 shows the result of performing the AND operation between FIG. 13 and FIG. 14.

FIG. 16 shows a three dimensional turn path at a corner between two planes/panels.

FIG. 17 shows the use of multiple slices bitmaps for routing large objects.

FIG. 18 shows a slice bitmap that intersects several objects to be avoided

FIG. 19 shows the result of applying a diffusion operator to FIG. 18 to grow the objects.

FIG. 20 shows a 3×3 diagonal diffusion filter.

FIG. 21 shows the result of applying FIG. 19 to a bitmap.

FIG. 22 is a flow chart of the A* router algorithm.

FIG. 23 shows typical route nodes.

FIG. 24 illustrates now to implement a restriction on the maximum allowed bend angle.

FIG. 25 illustrates now to impose other manufacturing restrictions.

FIG. 26 shows path alternatives at the corner between two guide planes.

FIG. 27 shows a compound route node that can jump directly to an arbitrary point.

### DESCRIPTION OF THE PREFERRED EMBODIMENTS

Before explaining the disclosed embodiments of the present invention in detail, it is to be understood that the invention is not limited in its applications to the details of the particular arrangements shown since the invention is capable of other embodiments. Also, the terminology used herein is for the purpose of description and not of limitation.

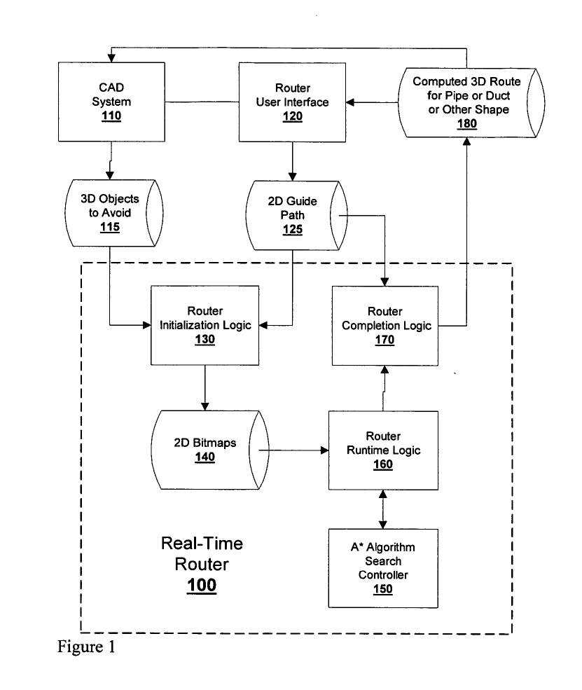

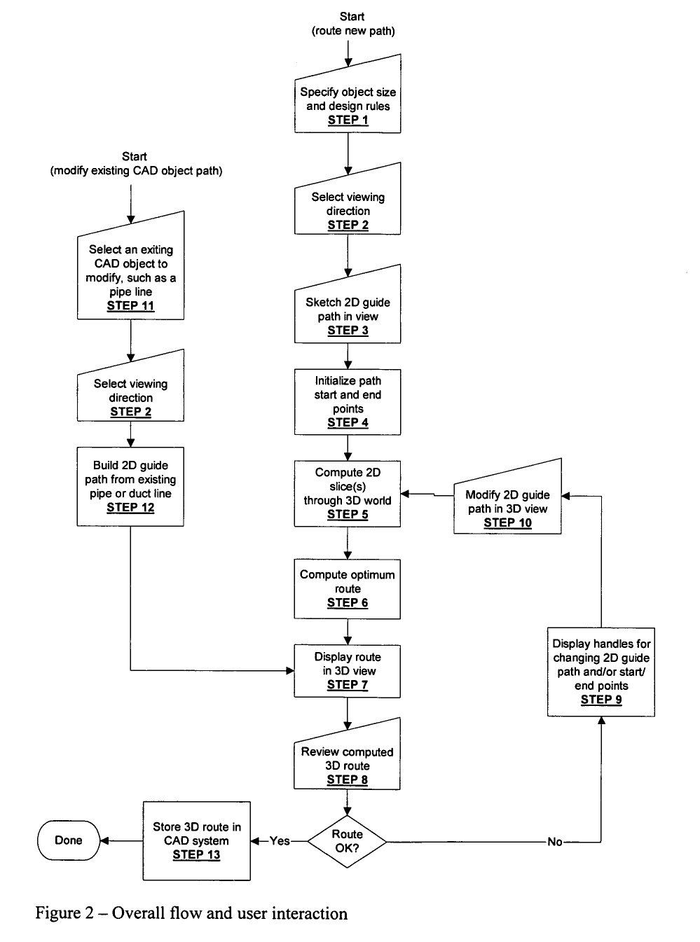

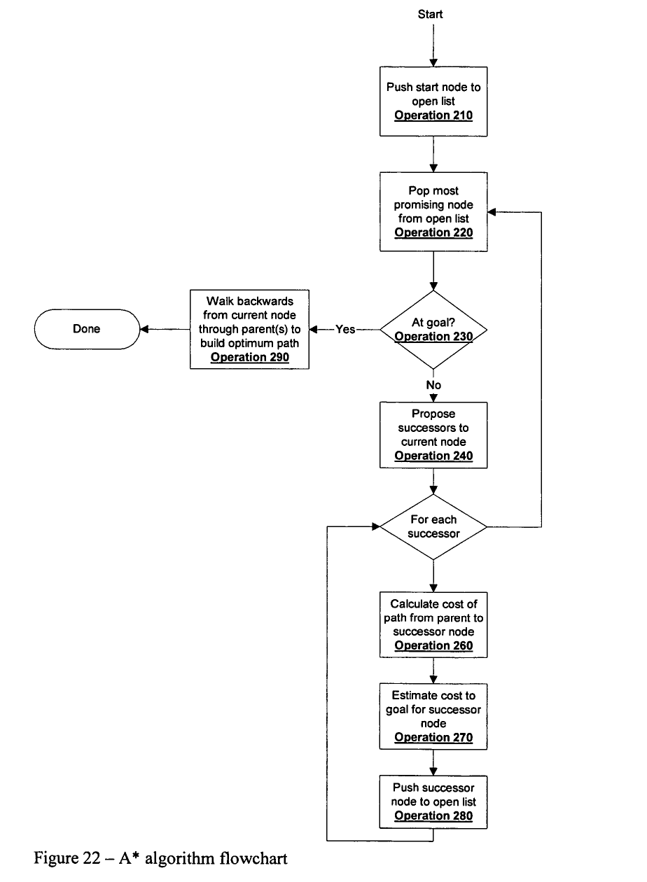

FIG. 1 is a block diagram of the major components of the Hybrid 3D Path Router that can include Real-Time Router 100, CAD system 110, 3D Objects to Avoid 115, Router User Interface 120, 3D Guide Path 125, Router Initialization Logic 130, 2D Bitmaps 140, A* Algorithm Search Controller 150 (described in reference to FIG. 22), Router Runtime Logic 160, and Router Completion Logic 170. FIG. 2 is a flow chart of overall flow and user interaction of the Hybrid 3D Path Router shown in FIG. 1. The router may be used to create new 3D paths, or to modify existing 3D paths. FIG. 2 is a combined flow chart which shows the data flow and user interaction for both of these applications.

An overview of the designer-user interaction using the invention will now be described. Referring to FIG. 2, the designer will use the main components of FIG. 1 to go through several user interaction steps as follows:

The designer uses the CAD System 110 to retrieve and display all objects (structure, equipment, existing pipes and ducts, etc.) in a region where one or more services (pipes, ducts, etc.) are to be routed. FIG. 2 will now be described.

STEP 1

For a new path, the designer specifies the dimension size and shape of the object to be routed (pipe diameter, for example), and references the operability, manufacturing and installation rules to be followed such as but not limited to those listed in Tables 1, 2 and 3 below, using the Router User Interface 120.

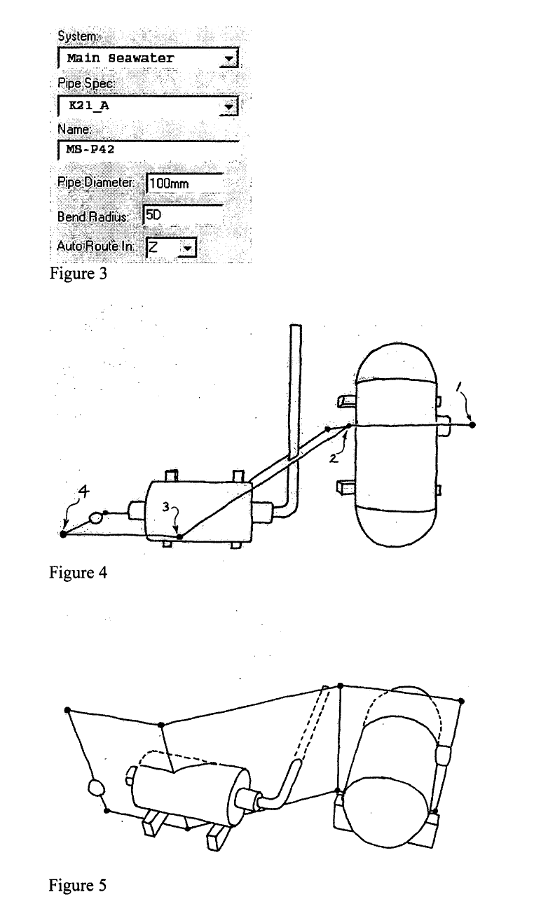

FIG. 3 shows a data entry screen for this function. Examples of operability rules would include whether pockets (changes in the sign of the vertical slope) are allowed, not allowed, or allowed but at an extra cost, and whether mitered turns or bends are required. Manufacturing rules describe the capabilities and limitations of the equipment, such as bending machines, that will be used to fabricate the pipes, ductwork, or other items of the route.

The router user interface 120 allows the designer to tag collections of CAD objects as supporting and or penetratable. Supporting objects are ones to which hangers could be attached to support the path. Penetratable objects are either objects in which holes can be cut (at a cost) for the path to pass through; or they are lower priority pipe/duct etc. runs which could be re-designed (at a cost) if necessary to make room for the current path being routed.

TABLE 1
Exemplary Operability Rules

| | |
|---|---|
| Slope | Drainage systems are subject to a minimum |
| | slope requirement |
| Pockets | Pockets (changes in the sign of the vertical slope) |
| | are prohibited in some systems |
| Separation | Hot systems may not be routed close to other |
| | systems that are temperature sensitive |
| Support | Supporting hangers must be provided, with minimum |
| | spacing requirements |
| Pressure Drop | Pressure drop requirements will determine |
| | whether mitered bends are allowed and will set minimum |
| | limits on the bend radius of bends, and may limit the |
| | number of bends allowed |
| Valve Access | Valve handles must be accessible for operation |

TABLE 2
Exemplary Manufacturing Rules

| | |
|---|---|
| Planar Bends | Available bending equipment may only support in-plane |
| | bends |
| Straight | If a straight section is not present between bends, the route |
| Between | must be fabricated as two separate pieces and then welded |
| Bends | together, at additional cost |
| Straight | Bending equipment may require a straight section before |
| Before/ | and after a bend. If the route does not contain these |
| After | straight sections, then the part will be fabricated from a |
| Bends | longer pipe and the extra straight sections will be cut off |
| | and discarded after bending, at additional cost. |
| Bend Angle | Available bending equipment will have minimum and |
| | maximum allowed bend angles |
| Cleaning | Bends must not restrict access to the interior of the route |
| After | for cleaning |
| Welding | |

TABLE 3
Exemplary Installation Rules

| | |
|---|---|
| Shared Hangers | Routing parallel to existing system routes reduces |
| | cost by allowing hangers to be shared |
| Weld Accessibility | Sufficient space must exist around welded joints to |
| | allow the joints to be welded |

STEP 2

The designer selects an appropriate viewing direction in which to work (X, Y, or Z axis, for example), using the Router User Interface 120.

STEP 3.

The designer sketches a two dimensional Guide Path 125 in that view. Four mouse clicks, for example, (labeled 1, 2, 3, and 4 in FIG. 4) would define the guide path shown in FIG. 4. In three dimensions, this guide path has actually defined a linked set of guide planes that the route will lie in, as shown in FIG. 5.

STEP 4

The Router Initialization Logic 130 searches the CAD System 110 memory or database for existing connectable objects (such as piping nozzles) near the start and end of the sketched guide path. If found, the path start and/or end are set to the connectable objects. Otherwise, the system assigns default locations for the third dimension of the path start and/or end locations.

STEP 5

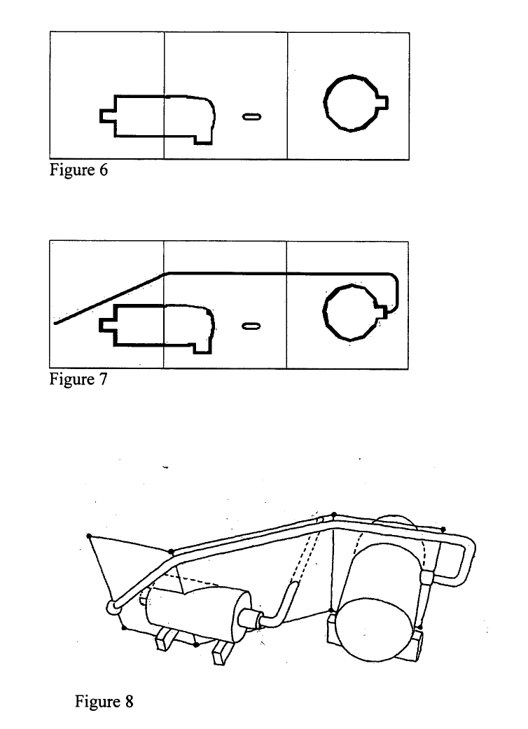

The Router Initialization Logic 130 computes slices through the three dimensional world 115 (provided by the CAD system) for each of these guide planes, as shown in FIG. 6. Next, bitmap images 140 are built for each slice plane by clipping and projecting the geometric objects to be avoided onto the slice planes.

Each bitmap image contains the boundary outlines of objects that must be avoided or a list of the objects to be avoided. Equipment, furniture, and other piping, ducting and services are examples of some of the objects to be avoided.

STEP 6

The Real-Time Router 100 automatically computes the optimum 2D path (following the guide planes) from the path start to the path end, as shown in FIG. 7. The router search controller 150 will try a large number of candidate paths and select the best found. The Router Runtime Logic 160 enforces all design and manufacturing rules that have been referenced by the designer as it computes the optimum path. The router is able to compute an optimum 2D path in real time because the Router Runtime Logic 160 has a very fast way to test candidate routes for interference with the objects to be avoided (using imaging operations on bitmaps), and the Router Initialization Logic 130 has provided a hint function which helps guide the router to evaluate most promising routes first and not get hung up at obstacles.

STEP 7

The Router Completion Logic 170 converts the optimum 2D path into a 3D path and passes it back to the Router User Interface 120 and CAD System 110 for display in the 3D view, as shown in FIG. 8. The Router User Interface 120 allows the designer to rotate and/or pan the 3D view to examine the proposed path.

STEP 8

The designer reviews the route proposed by by the Hybrid 3D Path Router. If the route is satisfactory, then STEP 13 is executed to store the results in the CAD system. If the route is not satisfactory to the designer, then the 2D guide path is modified via STEP 9.

STEP 9

As the designer moves his computer mouse over key points of the route slice planes in the 3D view, the Router User Interface 120 displays handles which allow the controlling parameters of the route path to be changed, as shown in FIG. 9. These include the height, location of connecting points between guide planes, path start and end location, and orientations.

STEP 10

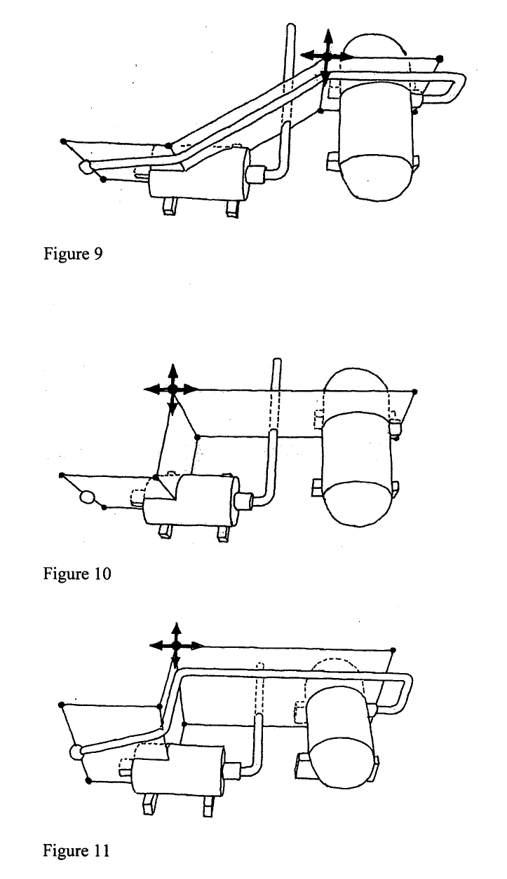

If the designer changes any of the controlling parameters, STEPS 5, 6, 7 and 8 are repeated. FIG. 10 shows the result of dragging one of the guide plane connecting point handles with the mouse. FIG. 11 shows the resulting optimum 3D path displayed after STEP 7 has completed.

The designer user interaction for modifying the 3D path for an existing CAD object, and is described below.

STEP 11

Using the CAD System 110, or the Router User Interface 120, the designer selects an existing already routed pipe or duct or other service from the CAD system.

STEP 2

The designer selects an appropriate viewing direction from which to work (X, Y, or Z axis for example) using the Router User Interface 120.

STEP 12

The Router User Interface 120 builds a 2D guide path from the existing pipe or duct path, which is then displayed in the 3D workspace via STEP 7. The remaining steps are the same as for the iterative modification loop when creating a new path, as shown in FIG. 2.

FIG. 1 is a block diagram of the major components of the Hybrid 3D Path Router. The listing of Major Components is as follows:
100 Real-Time Router
110 CAD system
115 3D Objects to Avoid
120 Router User Interface
125 3D Guide Path
130 Router Initialization Logic
140 2D Bitmaps
150 A* Algorithm Search Controller
160 Router Runtime Logic
170 Router Completion Logic

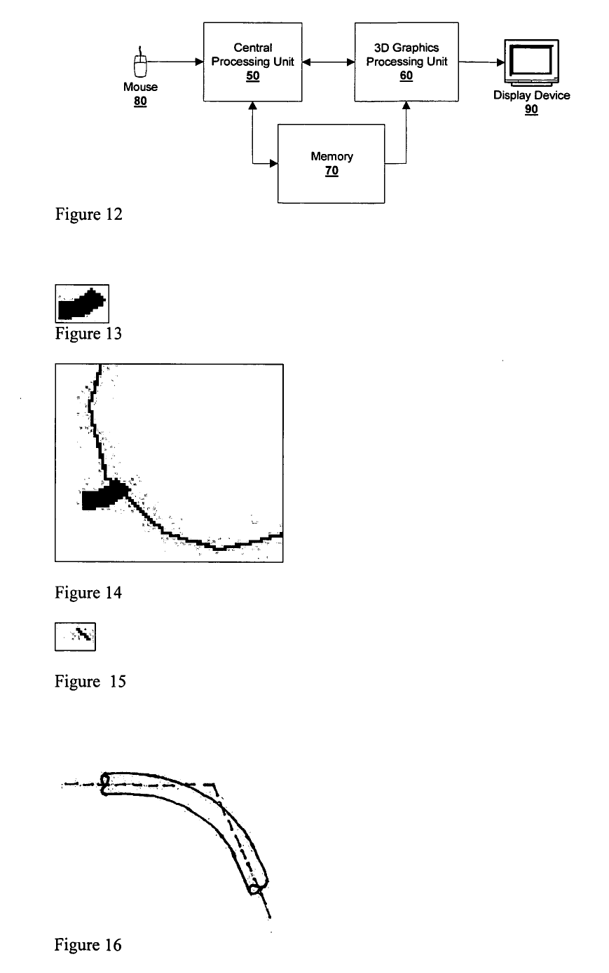

Referring to FIGS. 1 and 12, the invention can be implemented as a set of instructions for a CAD(computer aided design) type computer system, where the computer consists of a central processing unit 50, one or more memories 70, a 3D(three dimensional) graphics processing unit 60, a 2D(two dimensional) input device 80 such as a mouse, and a display device 90. The hybrid 3D path router can be imbedded directly in a CAD(computer assisted drawing) system 110, or can function as a separate program. The major software components and high level data flows are shown in FIG. 1. The CAD system 110 supplies the geometry of objects that must be avoided plus other information.

The router user interface 120 responds to mouse events from the computer and constructs, manipulates and displays a 2D guide path that the route is to follow. The router user interface 120 directs the real-time router to compute a path 125 after each mouse click.

Conventional CAD systems 110 that can incorporate the invention are described in various references, such as but not limited to U.S. Pat. No. 5,119,317 and U.S. Published Patent Application 2003/010029, both of which are incorporated by reference.

The real-time router 100 can consist of initialization, runtime, and completion logic plus an optimizing controller. The router initialization logic 130 processes the 3D(three dimensional) lists of objects to be avoided 115 and the 3D(three dimensional) guide path 125 and builds several compact bitmap representations (2D bitmaps) 140 of them. Objects to avoid might include, for example, equipment, furniture, and pipe, duct and other services that have already been routed. The A* algorithm search controller 150 (described in reference to FIG. 22) orchestrates an iterative search for an optimum path. The router runtime logic 160 proposes and evaluates path alternatives, in response to requests from the search controller 150. When the search controller 150 has finished, the router completion logic 160 retrieves the path found by the search controller 150, converts it from 2D to 3D, and delivers it to the CAD system 110. All of these functions can occur in real time.

Router User Interface 120

The router user interface 120 (FIG. 1) allows the designer to specify the size and type of object to be routed (pipe diameter, for example), and references design rules to be followed. It also allows the designer to select the “third” axis, that is, the axis along which the automatic router will solve for the third coordinate. This may be a coordinate axis (X, Y, or Z), or it might be perpendicular to some background CAD geometry.

The router user interface 120 allows the designer to tag collections of CAD objects as supporting and/or penetratable. Supporting objects are ones to which hangers could be attached to support the path. Penetratable objects are either objects in which holes can be cut (at a cost) for the path to pass through; or they are lower priority pipe/duct etc. runs which could be re-designed (at a cost) if necessary to make room for the current path being routed.

The CAD system 110 or the router user interface 120 provides a 3D viewing environment in which the designer may sketches a two dimensional guide path for the path, as illustrated in FIG. 4.

The router user interface 120 displays manipulator handles which allow the controlling parameters of the route path to be changed by dragging the manipulator handles with the mouse. Parameters controlled this way include the height, location of connecting points between guide planes, and path start and end location, and orientations.

As the designer moves his mouse over these manipulators, the mouse cursor changes to reflect the action that would be taken if the mouse button were pressed.

FIG. 9 shows the mouse cursor displaying a 2D arrow symbol indicating that the intersection point between two guide planes will be moved in two dimensions if the mouse button is pressed down and the mouse is moved (dragged). FIG. 10 shows the result of such a move. After each such move, the automatic router is invoked to compute a new optimum path, which is then displayed, as illustrated in FIG. 11.

Router Initialization Logic 130

The router initialization logic 130 (FIG. 1) will search the CAD system 110 memory or database and build several lists 115 of objects near the slice planes and then construct sets of bitmap images 140 which are a condensed voxel representation of those objects in the slice planes.

First, the 3D region defined by the slice planes is expanded by the length of the longest support hanger that would be allowed. The CAD database is searched for a list of all supportable objects within this region. A supportable object is defined as one from which a hanger or other supporting structure might be attached to support the pipe or duct or other element being routed.

Next, for each slice plane, the CAD database is queried for two lists of objects 115 that are contained in or intersect the volume defined by the slice plane. The first list is objects that must be avoided, and the second list is objects that may be penetrated at a cost. Walls, bulkheads, and decks are examples of objects in which it may be permissible, at a cost, to cut holes for the route to pass through.

The region near the intersection of each sequential pair of slice planes is then computed and the CAD database is queried again to build lists of objects that must be avoided and lists of objects that can be penetrated near each slice plane intersection. This information is required because 3D geometry of the bend in the path between slice planes is not contained entirely in the slice planes, as shown in FIG. 16.

Next, two bitmaps or lists of bitmaps are constructed for each slice plane. The first bitmap will contain an image of all objects that must be avoided that intersect or are contained in the slice plane. This will be a black and white bitmap. The second bitmap or bitmaps will contain an image of all penetrable objects that intersect or are contained in the slice plane. The color of each pixel in the penetrable bitmap represents the cost of the penetrating or moving the corresponding object.

These bitmaps are constructed using standard 3D computer graphics software and hardware, which is already a part of the CAD system 110(FIG. 1). The 3D graphics hardware/software is directed to create an orthogonal view looking perpendicular to the slice plane and with width and depth corresponding to the slice volume. The objects in the appropriate list (must avoid or penetratable) are then rendered to the standard 3D graphic display pipeline. This produces a bitmap on the display screen or in the computer memory. These bitmaps are copied and retained for the routing path.

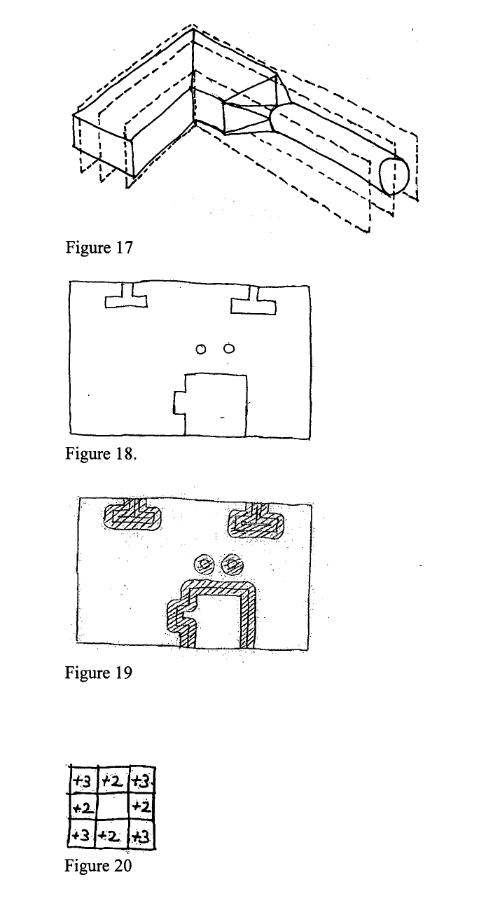

For objects that have a significant cross-sectional size, such as large pipes, ducts, and other large shapes, the system will compute multiple bitmap slices through the 3D world, as shown in FIG. 17, for each slice plane defined by the designer.

The next step is to automatically identify holes and narrow passageways through which the route might have to pass. For each slice plane, a copy is made of the objects to avoid bitmap, an example of which is shown in FIG. 18. A diffusion operator is then applied to grow the boundaries of each to-avoid-object by the size of the path being routed, as shown in FIG. 19. This image is then searched for narrow places. This search can be performed by applying simple image masks to the image, an operation which can be performed at very high speed by 3D graphics processing units. Such standard and conventional 3D graphics processing units are described in various patents such as but not limited to U.S. Pat. No. 6,452,595 to Montrym et al., which is incorporated by reference. The result of this operation is a list of narrow places or holes.

Heuristic Guidance

In order to run the 2D router algorithm in real time, it will be necessary to provide intelligent hints to the router as to which alternatives to explore first. For each slice plane, a distance-to-goal bitmap is created by the Router Initialization Logic 130(FIG. 1) as part of the set of 2D bitmaps 140. Each pixel in the bitmap will contains an approximation of the distance from that pixel to the goal point while avoiding objects. These images are computed by applying a diagonal diffusion operator starting with the last slice plane objects to avoid bitmap.

First, the images are initialized with the diffused objects to avoid bitmap created in the previous step. The goal pixel is labeled “0”. Immediate adjacent neighbors are labeled with the value of the center pixel plus a distance from it, unless the neighboring pixel has been labeled as a to-be-avoided region. Pixels to the immediate left and right, as well as those immediately above and below the goal will be labeled with “2” and the pixels on the diagonal corners with will be labeled with “3”. If the adjacent pixels are tagged as “to be avoided”, they are not labeled.

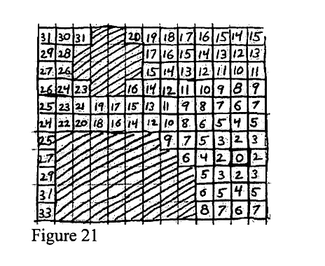

This process is repeated for the newly labeled pixels until every pixel in the image (that can be reached) has been labeled. FIG. 20 shows the 3×3 pixel diagonal diffusion operator. FIG. 21 shows an example of the result of applying this operator. When the distance-to-goal bitmap has been computed for the last slice plane, the values in its first column are copied to the last column of the distance-to-goal bitmap for the next previous slice plane, and the process repeated until all slice planes have been covered.

The costs of routing through penetratable objects and of hanger supports can also be factored into the distance-to-goal bitmap through similar procedures. To add in a cost for penetrating penetratable objects, the OR operator is used to merge penetratable objects bitmap with the objects to avoid bitmap, after mapping the colors in the penetratable objects bitmap into a reserved range of values. The diagonal diffusion operator is modified to look for these reserved values and to add them to the cost-to-goal estimate that it is diffusing.

An estimate of hanger support cost is factored in by applying a vertical diffusion operator which radiates up and down from each object that could support a hanger.

2D Router Search Controller 150

Any fast two dimensional software router 150(FIG. 1) for use with routers previously described can be used with the invention. One example is the A* router algorithm, described in Ref [4] Bryan Stout, The Basics of A* for Path Planning, Chapter 3.2 in Game Programming Gems, edited by Mark DeLoura, Charles River Media, 2000, which is nonessential subject matter incorporated by reference. FIG. 22 is a preferred flowchart for the A* algorithm.

Referring to FIG. 22, the A* algorithm requires that the problem be described in terms of nodes, with a start node and a goal node given initially in Operation 210. With the object oriented software metaphor, each node object must be capable of performing four functions when requested by the A* algorithm; plus an additional function required by the other functions. These functions are:

(1) GENERATE_SUCCESSORS (Operation 240): Propose successor nodes which advance the path

(2) COST_FROM_START (Operation 260): Calculate the cost of the path so far

(3) COST_TO_GOAL (Operation 270): Provide a quick heuristic lower bound estimate of the likely total cost of the remaining path from the node to the goal. This is used to help guide the search in exploring the most promising paths first.

(4) AT_GOAL (Operation 230): Determine if the node is at the goal

(5) INTERFERENCE_CHECK: Determine if the node path would have a volumetric interference with the objects that are to be avoided, or with the objects that may be penetrated (at an additional cost).

The A* algorithm maintains an “open” list of nodes to be explored. Nodes in this list are ranked by their estimated total path cost, as provided by adding the results of the COST_FROM_START and the heuristic COST_TO_GOAL estimate. At each iteration, the most promising node (the one with the lowest estimated total path cost) is taken from the open list, Operation 220) and is directed to propose successor nodes, which are then added to the “open” list. When the most promising node is at the goal, the algorithm is finished. The results are retrieved by following backwards from the goal node, Operation 290.

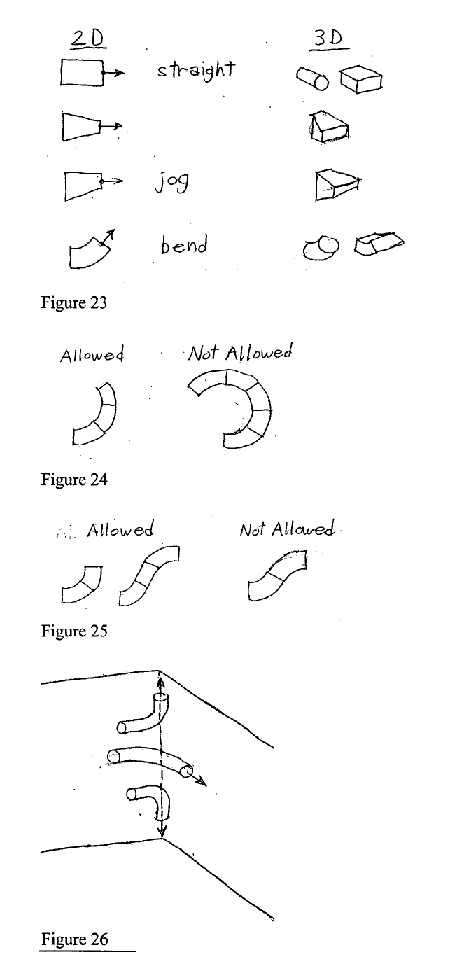

The route will be described by a list of nodes, where each node represents a small section of a path. Typical nodes are shown in FIG. 23. In the embodiment described here, the three dimensional routing problem has been converted to the simpler problem of routing between two nodes on a set of plane slices, as shown in FIG. 7. The data on each node includes a 2D origin and orientation on one of the slice planes and a 2D exit point and exit orientation on the slice plane (or on the next slice plane in the case of bends between slice planes). Each node will contain data on the cost so far and other information such as the distance from the nearest supporting structure. When routing ducting and other non-round shapes, each node will also contain entering and exiting shape information.

The key to the functioning of the system is the implementation of the four functions: Generate Successors (Operation 240), Interference Check, Cost from Start (Operation 260), and Cost toGoal (Operation 270) in FIG. 22 which are described below.

GENERATE_SUCCESSORS (Operation 240)

If the current node is a bend, the next node can be a bend of the same sense (clockwise or counterclockwise) unless the maximum allowed manufacturing bend angle has been reached, as shown in FIG. 24. Depending on the manufacturing process, a change in direction from clockwise to counterclockwise bending, without an intermediate straight section, may not be allowed, as shown in FIG. 25. In this case, the successor node for a counterclockwise bend will be either another counterclockwise bend or a straight section; but not a clockwise bend.

In general, from a given route node, the path may continue straight; may bend up or bend down; and/or may change cross-sectional shape. If the start node is given without an orientation, then a set of oriented successor start nodes are generated at some number of discreet orientations. If the current node is close to the intersection with the next bend slice, as shown in FIG. 26, then two types of successor nodes will be generated. First, one or more bends between the slice planes will be generated, and then bends turning up and turning down following the slice planes.

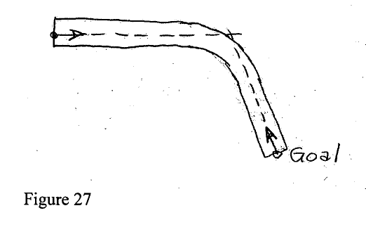

If the current node is on a slice plane containing either the goal or one or more possible holes in which to pass through, then a compound successor node is generated which describes a complete path from the current node to the goal or hole, as shown in FIG. 27. In effect, this causes the router to take discreet steps in open space; but to use exact solutions in the vicinity of the goal or narrow passages.

All potential successor nodes described above are first checked to see if they intersect with any objects to be avoided. If so, then are not proposed as a successor.

INTERFERENCE CHECK

First, for the special case for a node which represents a bend between two slice planes, as shown in FIG. 16, a triangulated representation of the bend is generated which is then tested against the list of objects to be avoided or penetrated at or near the intersection of that particular pair of slice planes. Most of the route nodes being considered will lie in the slice plane. The most time consuming calculation for any automatic router is checking potential paths for interference with objects to be avoided. To have a real time router, it is necessary to have an exceptionally fast interference checker which will not sacrifice accuracy. For each class of route nodes, a bitmap mask is maintained by the system. Determining whether the route node path would intersect any objects to be avoided can be computed by simply overlaying the mask on the slice plane bitmap and performing an AND operation, as shown in FIGS. 13, 14, and 15. If any pixels are on in the result of the AND operation, then an interference exists. This image AND operation can be performed by computer graphics hardware in microseconds.

COST_FROM_START (Operation 260)

Each node represents a possible path. The cost function may be computed to reflect the material, manufacturing, and installation costs of the path to date. In the simplest case, the cost function could be the length of the path thus far, plus an additional cost for each bend, plus the estimated cost of supporting the path.

First, the system performs a fast interference check between the node and the penetratable objects. If an interference is found, a cost penalty is added which corresponds to the cost of adding a hole to or moving/redesigning the “penetratable” object in question. For each node, the system will search the list of supportable objects to determine the distance required for a hanger and to estimate and add in the corresponding cost of a support hanger.

COST_TO_GOAL (Operation 270)

A heuristic estimate of the cost of the remaining path of a given successor node to the goal is obtained by sampling the cost to goal bitmap for the slice plane at the exit point of the node. This heuristic is key to the real time operation of the router, as it will cause the router to give first consideration to promising paths through holes, narrow passageways, and/or around obstacles.

The invention has great applicability to routing through congested areas such as those found in ships, nuclear plants, structures such as but not limited to offshore oil platforms, land vehicles, aircraft, and the like...

The invention can combine high speed real-time two dimensional router software and a simple graphical user interface to create an environment in which a designer can rapidly create fully valid 3D(three dimensional) routes for piping, HVAC(Heating, Ventilation and Air Conditioning) ducting, cableways and other swept shapes.

The invention can provides the designer with a tool which can generate optimal 3D routes nearly as fast as the designer can move his/her mouse. The invention can be used to modify and optimize the 3D(three dimensional) route of previously designed piping, ducting, cableways and other swept shapes as well. The invention can be imbedded within existing 3D(three dimensional) CAD(computer aided design) systems.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. A method of routing conduits such as ducts and pipes through congested areas, comprising the steps of:
(a) specifying dimensions and shape of an object to be routed through a space;
(b) sketching a 2D(two dimensional) guide path for the object through the space;
(c) calculating 2D(two dimensional) slices through a 3D(three dimensional) world for the guide path and building lists or other representations of the objects which cross or are contained in the slices;
(d) determining optimum 2D route through the 2D slices; and
(e) converting the optimum 2D route to an optimum 3D route.

2. The method of claim 1, further comprising the steps of:
(f) displaying the 3D route for review;
(g) modifying the 2D path if the 3D route in unacceptable, and repeating step (c);
(h) finalizing object path route if the displayed 3D route is acceptable.

3. The method of claim 1, wherein the space includes: a congested space.

4. The method of claim 3, wherein the congested space is selected from at least one of a ship, a land vehicle and an aircraft.

5. The method of claim 3, wherein the congested space is selected from at least one of: an industrial plant, a building and a structure.

6. The method of claim 1, further comprising the step of:
imbedding steps (a) through (h) in a CAD(computer aided design) system.

7. The method of claim 1, further comprising the step of:
routing of the conduit with steps (a) through (h) in real time.

8. The method of claim 1, further comprising the step of:
performing steps(a) through (h) with a real-time 2D(two dimensional) router and an intuitive graphical user interface to create an interactive 3D(three dimensional) router.

9. The method of claim 1, wherein step (c), further includes the step of:
determining objects to be avoided in the sketch path.

10. The method of claim 9, wherein step (c), further includes the step of:
projecting the objects to be avoided onto the slice planes.

11. The method of claim 10, wherein step (c), further includes the step of:
forming bit path masks by the objects to be avoided and the slices.

12. The method of claim 1 1, wherein step (d), further includes the step of:
comparing the bit path masks to determine the optimum 2D route.

13. The method of claim 9, wherein step (c), further includes the step of:
converting geometry of the objects to be avoided into bit map image masks of the objects to be avoided.

14. The method of claim 13, wherein step (d), further includes the step of:
comparing the bit map image masks to determine the optimum 2D route.

15. The method of claim 13, wherein step (c), further includes the step of;
generating a guidance cost function for the router by using a diffusion operator on the bit map image of the objects to be avoided.

16. The method of claim 1, further comprising the step of:
using interface manipulator handles to control and modify a 2D guide path to define a linked set of 3D guide planes.

17. The method of claim 13, further comprising the step of:
constructing bitmap based voxel representations of the objects to be avoided by 3D graphics hardware.

18. The method of claim 1, wherein steps (c) and (d) further include the step of:
combining discrete and continuous path routing with an A* algorithm.

19. The method of claim 1, where the conduit being routed is the installation and/or removal path for equipment.

20. The method of claim 1, where step (a) selects an object that already has a known 3D route and the remaining steps of claim 1 are used to modify and improve the 3D route.

21. The method of claim 1 where step (a) specifies objects to which path support hangers could be attached and step (d) determines an optimum route taking into account the cost of providing support hangers for the path.

22. The method of claim 1 where step (a) classifies some objects as being penetratable at additional cost and step (d) determines an optimum route taking into account the cost of any such penetrations.

23. The method of claim 1, wherein step (a) further includes the step of:
specifying manufacturing and installation and operability rules of the object to be routed through the space.

24. A system for routing conduits such as ducts and pipes through congested areas, the system comprises:
means for specifying object size and type to be routed through a space;
means for sketching a 2D(two dimensional) guide path for the object through the space;
means for calculating 2D(two dimensional) slices through a 3D(three dimensional) world for the guide path;
means for determining optimum 2D route through the 2D slices; and
means for converting the optimum 2D route to an optimum 3D route.
